(19) United States
(12) Patent Application Publication
(10) Pub. No.: US 2015/0008912 A1
(43) Pub. Date: Jan. 8, 2015

(54) METHOD AND DEVICE FOR DETECTING MECHANICAL CHANGES IN A COMPONENT BY MEANS OF A MAGNETOELASTIC SENSOR

(71) Applicant: Siemens Aktiengesellschaft, Munich (DE)

(72) Inventors: Carl Udo Maier, Stuttgart (DE); Jochen Ostermaier, Erlangen (DE)

(21) Appl. No.: 14/371,384

(22) PCT Filed: Dec. 20, 2012
(86) PCT No.: PCT/EP2012/076354

§ 371 Date: Jul. 9, 2014

(30) Foreign Application Priority Data
Jan. 9, 2012 (DE) 10 2012 200 201.4

(51) Int. Cl. G01N 27/82

(52) U.S. Cl. CPC G01N 27/82
USPC 324/238

(57) ABSTRACT

A method and a device detect mechanical changes in a component formed of a ferromagnetic material. The mechanical stress in the component is determined using at least one magnetoelastic sensor.

### CROSS REFERENCE TO RELATED APPLICATIONS

This application is based on and hereby claims priority to International Application No. PCT/EP2012/076354 filed on Dec. 20, 2012 and German Application No. 10 2012 200 201.4 filed on Jan. 9, 2012, the contents of which are hereby incorporated by reference.

### BACKGROUND

The present invention relates to a method and an arrangement for detecting mechanical changes in a component which comprises ferromagnetic material.

For nondestructive detection of mechanical weak points in materials, for example cracks, ultrasound is conventionally used. As an alternative to this, in the case of superficial cracks, the magnetic powder method or the dye penetrant method is used. There are furthermore destructive test methods, for example tensile testing or microsections. However, all these methods have the disadvantage that they cannot be used during ongoing operation of a machine, and online testing is not possible. Furthermore, removal of the component to be examined is usually necessary, with resulting long down times, assembly outlay and therefore shortened operating times.

### SUMMARY

It is therefore a first potential object to provide a method, which is improved in comparison with the described related art, for detecting mechanical changes, in particular cracks, or changes thereof as a function of time, the intention being for contactless detection to be possible, particularly during ongoing operation of a machine, without removal of the component to be examined being necessary. A second potential object is to provide an advantageous device for detecting mechanical changes in a component, which in particular is suitable for carrying out the method.

The inventors propose a method for detecting mechanical changes in a component relates to a component which comprises ferromagnetic material. In the scope of the method, the mechanical stress in the component is determined with the aid of at least one magnetoelastic sensor. The occurrence or presence of mechanical changes, for example cracks, in the component can be deduced from the stress determined.

The component to be examined may be formed of ferromagnetic material, for example iron, nickel, cobalt or ferrites. The mechanical changes to be detected may in particular be irreversible mechanical changes, for example cracks which have occurred. The mechanical stress to be determined may, for example, be the surface stress of the component. The component is preferably a component installed in a machine, the component being for example a potentially rotating shaft.

The magnetoelastic effect refers to the dependency of the permeability, in particular of ferromagnetic materials, on mechanical stress. The magnetic permeability is modified by the effect of a force on the material. As a result of the presence or occurrence of changes in the material or on the material surface, for example the presence or occurrence of cracks, the mechanical stresses in the material change. In the case of ferromagnetic materials, this causes a change in the magnetic permeability. By using a magnetoelastic sensor, the e.g. crack-induced permeability change can be measured, and used as a measure of the mechanical change, for example the crack formation.

The sensor need not be placed directly on the crack. By virtue of the contactless measurement principle, rotating shafts can also be monitored, for example for crack formation. Contactless detection of weak points in the material is thus possible. Furthermore, with the aid of the inventors' proposals, mechanical changes, for example, cracks can be identified, particularly during ongoing operation, i.e. for example in or on rotating shafts, without removal of the object to be measured being necessary.

Preferably, the mechanical stress may be determined as a function of time, to which end the mechanical stress may for example be determined at regular intervals and the measurement results may be compared with one another. In this way, for example in order to detect crack formation in a ferromagnetic material, the mechanical surface stress varying as a function of time may be measured on the material. Crack formation leads to a change in the magnetic permeability. In this way, changes can be detected not only in immediate proximity over the crack. The varying force profiles in the material, caused by the crack, furthermore make it possible to detect cracks in the wide vicinity of the sensor. Constant monitoring online is therefore also possible.

In principle, the mechanical stress may be determined by measuring the magnetic permeability. As already explained, the magnetoelastic sensor may preferably be arranged at a certain distance from the component during the measurement. In this way, contactless detection is made possible.

Furthermore, the position of the mechanical change on the component may be determined, i.e. for example the crack formation. This may, on the one hand, be done by moving at least one magnetoelastic sensor along the surface of the component to be examined, the determination of the mechanical stress being carried out position-dependently. The mechanical surface stresses may then be scanned by a mobile magnetoelastic sensor along the material to be examined. In this case, the sensor is moved over the component to be examined, and the measurement values are recorded.

Another possibility relates to using a plurality of magnetoelastic sensors, i.e. for example determining the mechanical stress in the component to be examined with the aid of at least two magnetoelastic sensors. To this end, the sensors must be placed in such a way that, at least in the case of two sensors, there is a change in the signal due to mechanical changes, for example cracks.

Furthermore, a plurality of magnetoelastic sensors, arranged next to one another, may be arranged along the surface of the component to be examined. In this case, the determination of the mechanical stress may take place position-dependently. By using such a sensor arrangement, in which magnetoelastic sensors placed next to one another, it is possible to cover the component region to be examined, position-resolved signals over the examination surface being achieved. The position of the mechanical change, for example of a crack, on the component may be determined by interpolation of the measurement data, in particular of the individual sensors. Interpolation of the measurement data of the individual sensors achieves refinement of the localization of the mechanical change.

Furthermore, the component to be examined may be dynamically excited. The resonant frequency, or the resonant frequencies, may then be determined position-dependently and/or time-dependently. A change in the material, for example crack formation, may then be deduced from a change or shift of the resonant frequencies. The component may in this case be dynamically excited artificially, that is to say by deliberately setting it in vibration or in oscillation, or by using existing oscillations. In this case, for example, the oscillations of a machine during ongoing operation may be used.

A combination of the static method described at the start, i.e. determination of the mechanical stress with the aid of a magnetoelastic sensor, with the dynamic method just described, i.e. determination of the resonant frequency, is particularly advantageous since the accuracy of the measurement principle is thereby increased.

Furthermore, the load-bearing capacity of the respective component, or of the material, may be determined by using wear models. This determination is in turn possible during ongoing operation of the machine comprising the corresponding component. Removal of the component to be examined is not necessary for determination of its load-bearing capacity.

The inventors also propose a device suitable for detecting mechanical changes in a component which comprises ferromagnetic material. The device comprises at least one magnetoelastic sensor. It is preferably configured for carrying out the proposed method as described above. The mechanical changes to be detected may be irreversible mechanical changes, for example crack formation.

The magnetoelastic sensor is preferably configured for time-resolved and/or position-resolved measurement. Preferably, the magnetoelastic sensor is configured for measuring the magnetic permeability and/or determining the mechanical stress, or the surface stress.

The magnetoelastic sensor may furthermore be arranged at a certain distance from the component to be examined. Furthermore, at least one magnetoelastic sensor may be arranged so that it can be moved along the surface of the component to be examined, in particular during the measurement. Furthermore, the device may comprise a plurality of magnetoelastic sensors arranged next to one another. For example, this allows simple position-resolved measurement.

The device may furthermore comprise a device for interpolating the measurement data of the individual sensors. Furthermore, the device may comprise a device or instrument for dynamic excitation of the component to be examined. The device may furthermore comprise a device for determining the resonant frequency, for example a corresponding magnetoelastic sensor.

The proposed device has in principle the same advantages as the proposed method as described above.

The time-dependent and position-resolved measurement of mechanical stresses with magnetoelastic sensor systems allows contactless monitoring of components for material changes, for example cracks, and the variations thereof as a function of time. If an installation is equipped with such a sensor system, crack testing is possible during operation.

Assembly outlay for removing and installing the components is therefore obviated, maintenance intervals become longer, service lives are increased and costs are therefore reduced. Furthermore, by this method it is possible to determine the time when, for example, the crack formation began. This offers significant advantages in cause research and the crack occurrence can therefore be associated better with a particular incident. By using wear models, it is thus furthermore possible to make predictions of the load-bearing capacity of the material during ongoing operation.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 schematically shows a component to be examined and a possible embodiment for the proposed device for detecting cracks in the component.

FIG. 2 schematically shows the stresses at various positions of the component, measured with the aid of the proposed method.

FIG. 3 schematically shows the scanning of the mechanical surface stress of the component by a mobile magnetoelastic sensor.

FIG. 4 schematically shows the examination of a component with the aid of a plurality of magnetoelastic sensors arranged next to one another.

FIG. 5 schematically shows the resonant frequency change caused by mechanical changes in the component.

FIG. 6 schematically shows an example of a combination of the static and dynamic methods.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

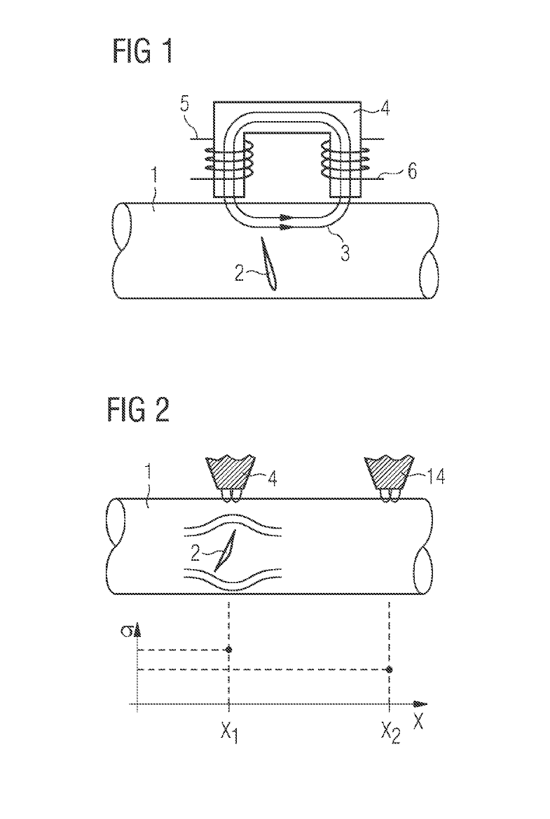

FIG. 1 schematically shows a component 1. The component 1 comprises ferromagnetic material, or formed of ferromagnetic material. The component 1 may in particular comprise iron, ferrites, cobalt or nickel. The component 1 may, for example, be a rotating shaft or another element of an assembled machine. With the aid of the proposed method, material changes existing or occurring in or on the component 1, for example cracks in the material, can be detected and localized. The component 1 shown in FIG. 1 has a crack 2 on its surface.

Because of the crack 2, the mechanical stress σ in the material changes. In the ferromagnetic material of the component 1, this causes a change in the magnetic permeability. In the scope of the present method, the detection and localization of the crack 2 is carried out with the aid of a magnetoelastic sensor 4.

The magnetoelastic sensor 4 comprises two sensor coils 5 and 6, namely an excitation coil 5 and a secondary coil or induction coil 6. In the excitation coil 5, a magnetic field 3 is generated which at least partially permeates through the component 1 to be examined. As a consequence of this, an electrical voltage is induced in the secondary coil 6. The mechanical stress σ in the component 1 to be examined, in the region which is permeated by the magnetic field 3, in this case determines the shape and strength of the magnetic field, so that an electrical voltage which is proportional to the mechanical stress σ in the examined region of the component 1, i.e. the region which is permeated by the magnetic field 3, is induced in the secondary coil 6.

In the example shown in FIG. 1, the mechanical stress in the component 1, in the region of the crack 2, is modified by the crack 2. This stress σ, differing from other regions of the component 1, is detected and localized with the aid of the magnetoelastic sensor 4. The magnetoelastic sensor 4 need not in this case come in direct contact with the component 1 to be examined. The examination of the component 1 can thus also be carried out during ongoing operation of the respective machine.

FIG. 2 schematically shows the contactless measurement by rigidly applied magnetoelastic sensors 4 and 14 for measuring the surface stresses of the component 1 in immediate proximity over the crack 2 and outside the immediate vicinity of the crack 2. The respectively measured stress σ is schematically plotted in arbitrary units as a function of the respective position coordinate x in the diagram below the component 1. A first magnetoelastic sensor 4 and a second magnetoelastic sensor 14 are arranged at a particular distance from the component 1 to be examined. The first magnetoelastic sensor 4 is located at the position x₁ in relation to the x direction, and the second magnetoelastic sensor 14 is located at the position x₂. In the region of the position coordinate x₁, the component 1 has a crack 2. Correspondingly, the first magnetoelastic sensor 4 determines a surface stress σ(x₁) which differs from the surface stress σ(x₂) determined with the aid of the second magnetoelastic sensor 14. This is denoted in the diagram σ(x) in FIG. 2 by black dots. In the example shown in FIG. 2, in the region of the crack 2, i.e. at the position x₁, a stress σ of greater magnitude is determined than at a position x₂ at which the material is undamaged.

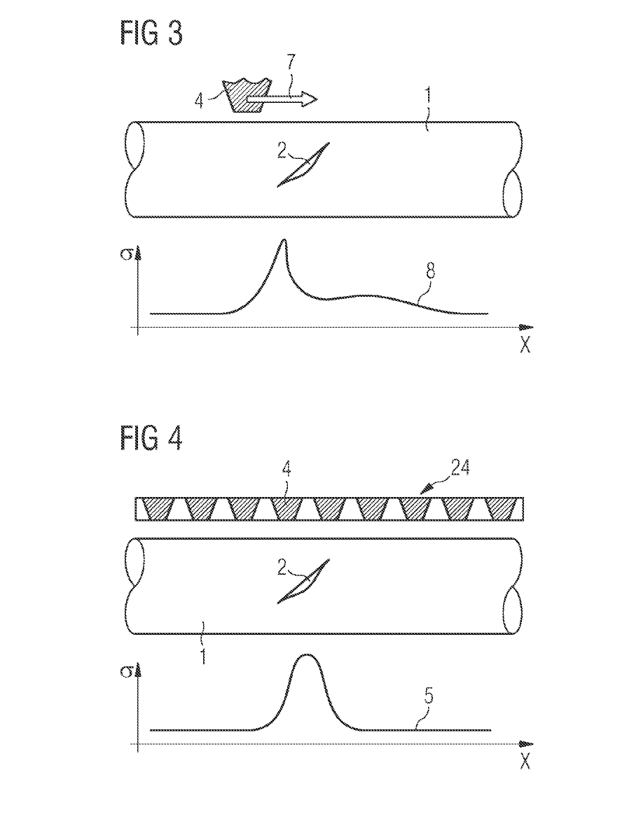

Another variant relates to scanning the surface of the component 1 with the aid of a magnetoelastic sensor 4. This is schematically shown in FIG. 3. FIG. 3 shows the component 1 and a magnetoelastic sensor 4, which is guided along the surface of the component 1 in the x direction, this being denoted by the reference 7. The stress σ determined as a function of the respective x coordinate is plotted as curve 8 in the diagram σ(x). In the region of the crack 2, the measurement curve 8 has a maximum which allows localization and quantification of the crack in terms of its size, i.e. its extent or depth.

An alternative variant is shown in FIG. 4. FIG. 4 schematically shows the component 1 and a sensor arrangement 24 arranged close to the surface of the component 1. The sensor arrangement 24 comprises a plurality of magnetoelastic sensors 4, which are arranged in a row next to one another. With the aid of the magnetoelastic sensors 4 arranged next to one another, a position-resolved signal is measured over the examination surface, i.e. the surface of the component 1. The stresses a determined as a function of the respective position coordinates x are plotted as measurement curve 9 in the diagram shown in FIG. 4. The plotted stress σ is in this case given in arbitrary units. The measurement curve 9 has a maximum in the region of the crack 2, so that the crack 2 can be localized. For more accurate localization of the crack 2, refinement of the localization can be achieved by interpolation of the measurement data of the individual sensors 4.

Another alternative embodiment is schematically shown in FIG. 5. FIG. 5 shows the component 1 and a magnetoelastic sensor 34 arranged movably in proximity to the surface of the component 1. The component 1 is dynamically excited. This is denoted by arrows 31 and 32, arrow 31 being intended to denote transverse oscillations and arrow 32 being intended to denote longitudinal oscillations. In principle, the dynamic excitation may be carried out artificially or by using existing oscillations, for example oscillations of the machine while it is running.

With the aid of the magnetoelastic sensor 34, the respective resonant frequency ωᵣₑₛ is determined with position resolution. To this end, the magnetoelastic sensor 34 is moved along the surface of the component 1. This is denoted by an arrow 37. The measured resonant frequency ωᵣₑₛ, or the amplitude A, is shown as a function of the respective frequency ω as measurement curve 10 in the diagram in FIG. 5. The amplitude A, plotted in arbitrary units, has maxima in the region of a first resonant frequency ωᵣₑₛ¹ and a second resonant frequency ωᵣₑₛ². As a consequence of changes in the material of the component 1, i.e. for example as a consequence of the occurrence of the crack 2, the resonant frequencies ωᵣₑₛ are shifted, or change. The time of a change in the material, for example crack formation, can be deduced from the change or shift of the resonant frequencies as a function of time.

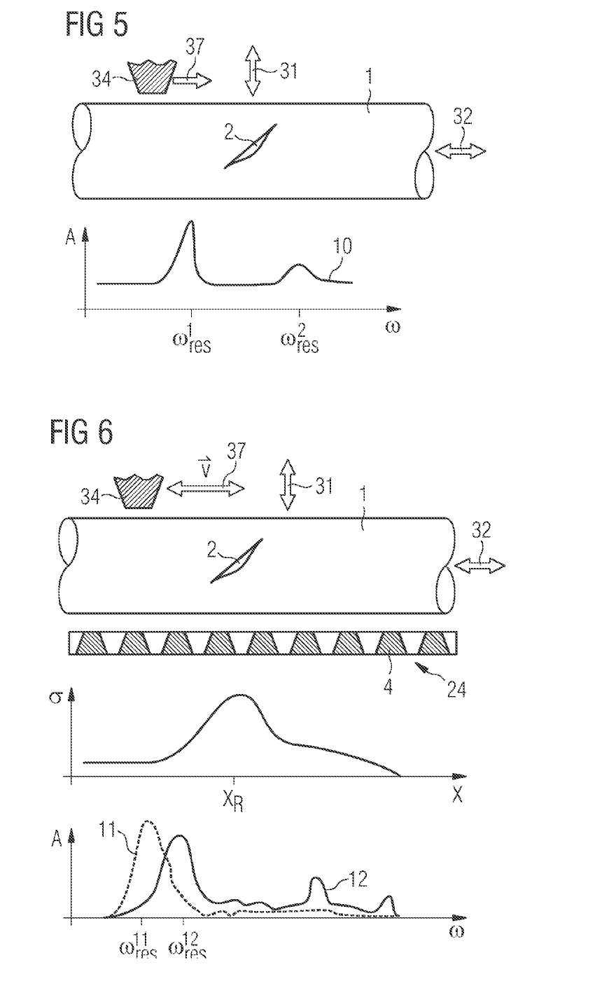

FIG. 6 schematically shows a combination of the static method described in connection with FIG. 4 and the dynamic method described in connection with FIG. 5. The sensor arrangement 24 described in connection with FIG. 4, has magnetoelastic sensors 4 arranged next to one another, is in this case arranged in proximity to the component 1. Furthermore, a mobile magnetoelastic sensor 34 is arranged in proximity to the surface of the component 1.

As already described in connection with FIG. 5, the component 1 is dynamically excited and the resonant frequency ωᵣₑₛ is determined by displacing the mobile magnetoelastic sensor 34. At the same time, the stress in the component 1 is determined with position resolution with the aid of the sensor arrangement 24. The stress σ(x) determined has a maximum in the region of the position coordinate x_{R} of the crack 2, so that localization of the crack 2 is possible.

Furthermore, determination of the resonant frequency ωᵣₑₛ carried out at different times, and comparison of the resonant frequencies measured at different times with one another, makes it possible to determine the time of the occurrence of the crack 2. In the lower diagram in FIG. 6, the amplitude A measured for the respective frequencies ω is plotted in arbitrary units for two different times. The dashed measurement curve 11 denotes the measurement before the occurrence of the crack 2. Measurement curve 11 shows a resonant frequency ωᵣₑₛ¹¹. The solid curve 12 denotes a measurement after the occurrence of the crack 2. The measurement curve shows a resonant frequency ωᵣₑₛ¹², which is shifted to a higher frequency compared with the resonant frequency ωᵣₑₛ¹¹ measured before the occurrence of the crack 2.

By corresponding type-dependent measurements, time-varying mechanical surface stresses can accordingly be measured on a material and can be used, for example, to detect crack formation in a ferromagnetic material. In this way, on the one hand, the time of the occurrence of the material change, for example the crack, as well as the strength and position of the material change can be determined. This can be carried out contactlessly, so that time and costs for removing and installing the respective component can be saved on, and down times can be avoided.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method comprising:
providing a component which comprises ferromagnetic material;
using a magnetoelastic sensor to determine a mechanical stress σ in the component; and
detecting a mechanical change in the component from the mechanical stress σ.

17. The method as claimed in claim 16, wherein
the mechanical stress σ is determined as a function of time.

18. The method as claimed in claim 16, wherein
the mechanical stress σ is determined by measuring magnetic permeability.

19. The method as claimed in claim 18, wherein
the magnetoelastic sensor is arranged at a certain distance from the component during measurement of the magnetic permeability.

20. The method as claimed in claim 16, wherein
the component extends in an x-direction, and
a position in the x-direction of the mechanical change in the component is determined.

21. The method as claimed in claim 16, wherein
the magnetoelastic sensor is moved along a surface of the component, and
the mechanical stress σ is determined position-dependently.

22. The method as claimed in claim 16, wherein
a plurality of magnetoelastic sensors are arranged next to one another along a surface of the component, and
the mechanical stress σ is determined position-dependently.

23. The method as claimed in claim 16, wherein
the mechanical stress σ is determined at a plurality of measurement locations across a surface of the component, and
interpolation of the mechanical stress σ between the measurement locations is used to locate the mechanical change in the component.

24. The method as claimed in claim 16, wherein
the component is dynamically excited, and
a resonant frequency ω of the component is determined position-dependently and/or time-dependently.

25. The method as claimed in claim 24, wherein the component is dynamically excited artificially or by using existing oscillations.

26. The method as claimed in claim 16, wherein
a load-bearing capacity of the component is determined by using wear models.

27. The method as claimed in claim 16, wherein
the component is a rotor shaft that rotates about an axis, and
a plurality of magnetoelastic sensors are arranged next to one another, spaced apart in an axial direction of the rotor shaft.

28. The method as claimed in claim 16, wherein
the magnetoelastic sensor produces measurement results at respective different measurement locations across a surface of the component, and
the mechanical change in the component is detected by analyzing how the measurement results change with time and by analyzing how the measurement results change across the surface of the component.

29. The method as claimed in claim 16, wherein
the magnetoelastic sensor comprises an excitation coil and an induction coil, both of which are positioned adjacent to but not contacting a surface of the component, and
a magnetic field is generated in the excitation coil and an electric voltage is induced in the induction coil to determine the mechanical stress in the component.

30. The method as claimed in claim 16, wherein
the magnetoelastic sensor is spaced away from the component for contactless determination of the mechanical stress σ in the component,
the component is part of a larger device, and
the mechanical stress σ in the component is determined while the component is in operation, without removing the component from the larger device.

31. A device to detect a mechanical change in a component which comprises ferromagnetic material, the device comprising:
at least one magnetoelastic sensor to determine a mechanical stress σ in the component, from which the mechanical change is detected.

32. The device as claimed in claim 31, wherein
the magnetoelastic sensor is configured for time-resolved and/or position-resolved measurement.

33. The device as claimed in claim 31, wherein
the magnetoelastic sensor is arranged at a distance from the component, and/or at least one magnetoelastic sensor is arranged so that it can be moved along a surface of the component.

34. The device as claimed in claim 31, wherein
a plurality of magnetoelastic sensors are arranged next to one another along a surface of the component.

35. The device as claimed in claim 31, wherein
the component extends in an x-direction,
a plurality of first magnetoelastic sensors are arranged next to one another, spaced apart in the x-direction along a surface of the component,
the plurality of first magnetoelastic sensors measure magnetic permeability,
a second magnetoelastic sensor is moved in the x-direction along the surface of the component, and
the second magnetoelastic sensor determines a resonant frequency ω of the component.
